(19) United States
(12) Patent Application Publication
(10) Pub. No.: US 2024/0135925 A1
(43) Pub. Date: Apr. 25, 2024

(54) ELECTRONIC DEVICE FOR PERFORMING SPEECH RECOGNITION AND OPERATION METHOD THEREOF

(71) Applicant: SAMSUNG ELECTRONICS CO., LTD., Suwon-si (KR)

(72) Inventors: Gilho Lee, Suwon-si (KR); Gajin Song, Suwon-si (KR); Hoseon Shin, Suwon-si (KR); Jungin Lee, Suwon-si (KR); Seokyeong Jeong, Suwon-si (KR)

(73) Assignee: SAMSUNG ELECTRONICS CO., LTD., Suwon-si (KR)

(21) Appl. No.: 18/377,636

(22) Filed: Oct. 6, 2023

Related U.S. Application Data
(63) Continuation of application No. PCT/KR23/15452, filed on Oct. 6, 2023.

(30) Foreign Application Priority Data
Oct. 7, 2022 (KR) 10-2022-0129087
Oct. 18, 2022 (KR) 10-2022-0133815

(51) Int. Cl. G10L 15/22; G06F 40/279; G10L 15/26

(52) U.S. Cl. CPC G10L 15/22; G06F 40/279; G10L 15/26

(57) ABSTRACT

An electronic device according to an embodiment may include a microphone, a memory, and at least one processor(s). According to an embodiment, the at least one processor may be configured to acquire speech data corresponding to a user's speech via the microphone. The at least one processor according to an embodiment may be configured to acquire first text recognized on speech data by at least partially performing automatic speech recognition and/or natural language understanding. The at least one processor according to an embodiment may be configured to identify, based on the first text, second text stored in the memory. The at least one processor according to an embodiment may be configured to control to output the first text or the second text as a speech recognition result of the speech data, based on a difference between the first text and the second text. The at least one processor according to an embodiment may be configured to acquire training data for recognition of the user's speech, based on relevance between the first text and the second text with respect to the speech data.

### CROSS-REFERENCE TO RELATED APPLICATIONS

This application is a continuation of International Application No. PCT/KR2023/015452 designating the United States, filed on Oct. 6, 2023, in the Korean Intellectual Property Receiving Office and claiming priority to Korean Patent Application No 10-2022-0129087, filed Oct. 7, 2022 in the Korean Intellectual Property Office and Korean Patent Application No. 10-2022-0133815 filed Oct. 18, 2022 in the Korean Intellectual Property Office, the disclosure of which are incorporated by reference in their entireties.

### FIELD

The disclosure relates to an electronic device for performing speech recognition and an operation method thereof.

### DESCRIPTION OF RELATED ART

Various services and additional functions provided through electronic devices, for example, a portable electronic device such as a smartphone, are gradually increasing. In order to increase the utility values of such electronic devices and satisfy the needs of various users, communication service providers or electronic device manufacturers offer various functions, and develop electronic devices competitively to differentiate the same from those of other companies. Accordingly, various functions provided via electronic devices are becoming more advanced. Recently, various types of intelligence services for electronic devices have been provided, and a speech recognition service, which is one of these intelligence services, may provide various services to users by controlling electronic devices via speech recognition.

For example, a control technology using speech recognition is to analyze speech (command) received via utterance of a user and provide a service that is most suitable for a request (command) of the user, and allows a user to control an electronic device more easily compared to directly controlling a physical or mechanical button provided on the electronic device or controlling the electronic device by an input via a user interface displayed on a touch-enabled display or an additional input device, such as a mouse or a keyboard, so that use of the control technology using speech recognition is gradually increasing.

### SUMMARY

An electronic device 101 according to an embodiment may include a microphone 140, a memory 130, and at least one processor 120 and 125. According to an embodiment, the at least one processor may be configured to acquire speech data corresponding to a user's speech via the microphone. The at least one processor according to an embodiment may be configured to acquire a first text recognized on the speech data by at least partially performing at least one of automatic speech recognition (ASR) or natural language understanding (NLU). The at least one processor according to an embodiment may be configured to identify, based on the first text, a second text stored in the memory. The at least one processor according to an embodiment may be configured to control to output the first text or the second text as a speech recognition result of the speech data, based on a difference between the first text and the second text. The at least one processor according to an embodiment may be configured to acquire training data for recognition of the user's speech, based on relevance between the first text and the second text with respect to the speech data.

An operation method of an electronic device 101 according to an embodiment may include acquiring speech data corresponding to a user's speech via a microphone 140 included in the electronic device. The operation method of the electronic device according to an embodiment may include acquiring a first text recognized on the speech data by at least partially performing at least one of automatic speech recognition (ASR) or natural language understanding (NLU). The operation method of the electronic device according to an embodiment may include identifying, based on the first text, a second text stored in the electronic device. The operation method of the electronic device according to an embodiment may include controlling to output the first text or the second text as a speech recognition result of the speech data, based on a difference between the first text and the second text. The operation method of the electronic device according to an embodiment may include acquiring training data for recognition of the user's speech, based on relevance between the first text and the second text with respect to the speech data.

A non-transitory recording medium 130 according to an embodiment may store a program configured to perform acquiring speech data corresponding to a user's speech via a microphone 140 included in an electronic device 101, acquiring a first text recognized on the speech data by at least partially performing at least one of automatic speech recognition (ASR) or natural language understanding (NLU), identifying, based on the first text, a second text stored in the electronic device, controlling to output the first text or the second text as a speech recognition result of the speech data, based on a difference between the first text and the second text, and acquiring training data for recognition of the user's speech, based on relevance between the first text and the second text with respect to the speech data.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a schematic configuration of an electronic device performing speech recognition according an embodiment;

FIG. 2A is a block diagram illustrating a schematic configuration of an electronic device according to an embodiment;

FIG. 2B is a flowchart illustrating acquiring of training data for speech recognition while performing speech recognition by an electronic device, according to an embodiment;

FIG. 3 is a block diagram illustrating a configuration of an electronic device performing speech recognition, according to an embodiment;

FIG. 4 is a flowchart illustrating performing speech recognition by an electronic device, according to an embodiment;

FIG. 5 is a flowchart illustrating acquiring of training data for speech recognition by an electronic device, according to an embodiment;

FIG. 6 is a flowchart illustrating acquiring of second text stored in a memory by identifying an utterance intent in speech data by an electronic device, according to an embodiment;

FIG. 7A and FIG. 7B are diagrams illustrating identifying of an utterance intent in speech data by an electronic device, according to an embodiment;

FIG. 8A shows diagrams illustrating correcting of first text obtained by speech recognition, based on second text stored in the memory of an electronic device, and using the same, according to an embodiment;

FIG. 8B is a table showing weights for identifying, by an electronic device, whether the difference between first text and second text is equal to or less than a threshold, according to an embodiment;

FIG. 9 is a flowchart illustrating performing training for recognizing a user's speech by updating a feature analysis model by an electronic device, according to an embodiment;

FIG. 10 is a block diagram illustrating an integrated intelligence system, according to an embodiment;

FIG. 11 is a diagram illustrating association information between a concept and an action stored in a database, according to an embodiment;

FIG. 12 is a diagram illustrating a user terminal which displays a screen for processing of a speech input received via an intelligence app, according to an embodiment; and

FIG. 13 is a block diagram of an electronic field in a networked environment, according to various embodiments.

### DETAILED DESCRIPTION

An electronic device providing a speech recognition service may learn a speech recognition model to perform speech recognition. For example, the electronic device may use a speech database in order to learn the speech recognition model. The speech database may include a speech signal in which a user's speech is recorded, and text information obtained by transcribing a content of the corresponding speech into characters. For example, the electronic device may learn a speech recognition model while matching the user's speech signal with the text information. If text information and actual speech do not match, the electronic device is unable to perform learning of a high-quality speech recognition model. Accordingly, the electronic device is unable to perform high-quality speech recognition.

In general, since a speech database used for learning of a speech recognition model is supplied via inspection by an issuance institution, there may be no quality problem. However, such a commonly used speech database may not be able to properly recognize a user's utterance having a different utterance characteristic.

In a conventional electronic device providing a speech recognition service, a sentence enabling identification of an utterance characteristic of a user is generated in advance, and the user reads and records the corresponding sentence, thereby updating a speech database. Alternatively, when mis-recognition occurs during speech recognition, the conventional electronic device is able to acquire text manually corrected by a user. However, the above-described methods have a problem in terms of convenience because a user needs to separately invest time and effort before or during the use of a speech recognition service.

An embodiment of the disclosure may provide a method for, while performing speech recognition of converting a user's speech into text, acquiring training data for recognition of the user's speech via acquired speech data and text pre-stored in an electronic device.

An electronic device according to an embodiment of the disclosure may acquire a speech database suitable for a user's utterance characteristic without investing time and effort by the user. Accordingly, the electronic device according to an embodiment of the disclosure may provide an accurate and convenient speech recognition service in consideration of a user's utterance characteristic.

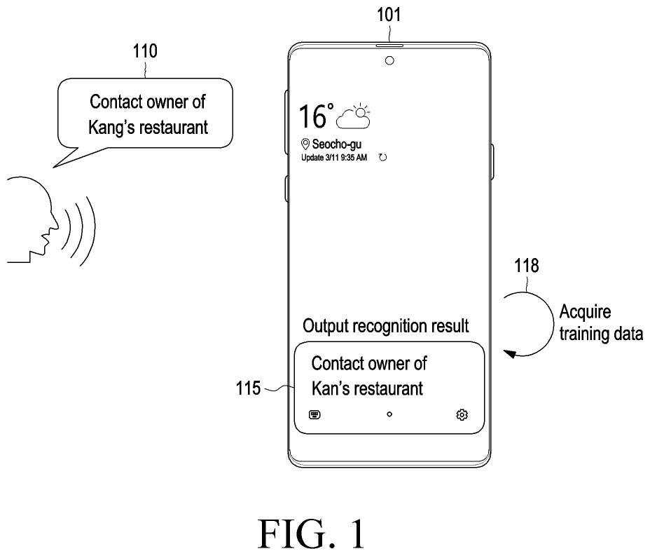

FIG. 1 is a diagram illustrating a schematic configuration of an electronic device performing speech recognition according an embodiment.

Referring to FIG. 1, according to an embodiment, an electronic device 101 is an electronic device having a speech recognition function, and may receive speech uttered by a user via a microphone, and recognize a speech input signal received via the microphone according to the user's utterance, thereby outputting a result thereof via a display or speaker.

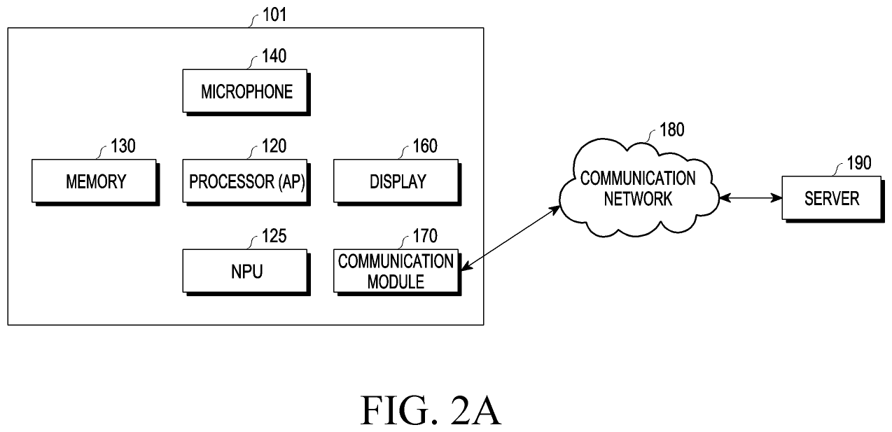

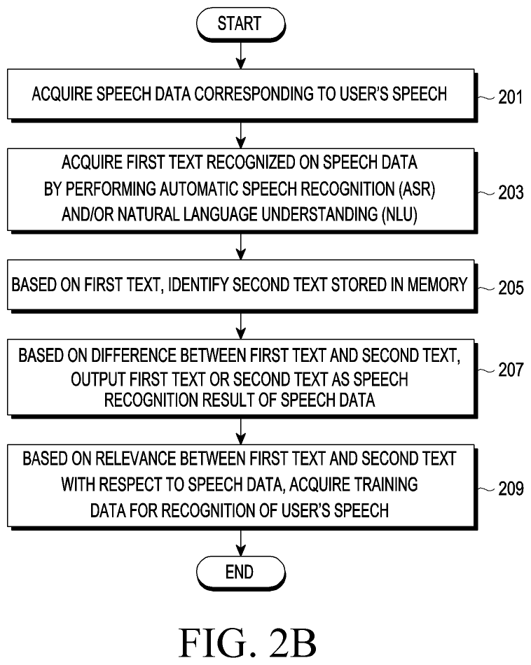

Speech recognition processing on speech data according to an embodiment may include partially processing automatic speech recognition (ASR) and/or natural language understanding (NLU). According to an embodiment, the speech recognition process may be processed by a speech recognition module stored in the electronic device 101 or by a server (e.g., reference numeral 190 of FIG. 2A).

According to an embodiment, the electronic device 101 may acquire speech data (or speech signal) corresponding to a user's speech 110. For example, the electronic device 101 may acquire speech data (or speech signal) corresponding to “Contact the owner of Kang's restaurant”. For example, the electronic device 101 may be implemented as a smartphone.

According to an embodiment, the electronic device 101 may at least partially perform automatic speech recognition (ASR) and/or natural language understanding (NLU) so as to acquire text by performing speech recognition on the speech data.

According to an embodiment, the electronic device 101 may output speech-recognized text 115 as a recognition result. For example, the speech-recognized text 115 may be, “Contact the owner of Kan's restaurant”. For example, the speech-recognized text 115 may be recognized differently from the user's intent according to an utterance characteristic of the user. For example, although a content of the user's utterance is “Contact the owner of Kang's restaurant”, the electronic device 101 may recognize the utterance as “Contact the owner of Kan's restaurant”.

According to an embodiment, the electronic device 101 may correct the speech-recognized text 115, based on pre-stored data (e.g., contact information, an application name, and schedule information). For example, the electronic device 101 may correct “the owner of Kan's restaurant” to “the owner of Kang's restaurant”. For example, “the owner of Kang's restaurant” may be information included in the contact information. Therefore, the electronic device 101 may output or display “Contact the owner of Kang's restaurant” via the display included in the electronic device 101.

According to an embodiment, the electronic device 101 may acquire 118 training data for recognition of the user's speech while performing speech recognition. The electronic device 101 may acquire speech data while performing speech recognition, and acquire text information transcribed into characters via data pre-stored in the electronic device 101. That is, the electronic device 101 may acquire text information transcribed into reliable characters while performing speech recognition. Accordingly, the electronic device 101 may acquire training data for recognition of the user's speech without performing an additional operation.

FIG. 2A is a block diagram illustrating a schematic configuration of an electronic device according to an embodiment.

Referring to FIG. 2A, the electronic device 101 may include at least one of a processor 120, an NPU 125, a memory 130, a microphone 140, a display 160, and a communication module 170.

According to an embodiment, the processor 120 may control overall operations of the electronic device 101. For example, the processor 120 may be implemented as an application processor (AP).

According to an embodiment, the processor 120 may acquire speech data (or speech signal) corresponding to a user's speech via the microphone 140.

According to an embodiment, the processor 120 may at least partially perform automatic speech recognition (ASR) and/or natural language understanding (NLU) with respect to speech data. The processor 120 may acquire first text by performing speech recognition on speech data. For example, the first text may be text information including transcribed characters.

According to an embodiment, the processor 120 may identify second text stored in the memory 130, based on the first text. For example, the processor 120 may identify an utterance intent of the user by analyzing the first text. The processor 120 may search for related information stored in the memory 130 in consideration of the utterance intent. For example, if the utterance intent is identified to be making a call, the processor 120 may identify the second text corresponding (or identical or similar) to the first text in contact information stored in the memory 130. For example, the second text may include application information (e.g., an application name) and/or personal information (e.g., information on contacts, schedules, locations, and times) of the user stored in the memory (130).

According to an embodiment, the processor 120 may divide each of the first text and the second text in units of phonemes. The processor 120 may identify the difference between the first text and the second text, based on a similarity between multiple first phonemes (e.g., consonants and vowels) included in the first text and multiple second phonemes (e.g., consonants and vowels) included in the second text. For example, the processor 120 may determine the similarity by applying weights to differences between the first phonemes and the second phonemes, respectively. The processor 120 may identify the difference between the first text and the second text, based on a value indicated by the similarity.

According to an embodiment, the processor 120 may output the first text or the second text as a result of speech recognition of the speech data, based on the difference between the first text and the second text. For example, the processor 120 may output a speech recognition result via the display 160 and/or a speaker. For example, if the difference between the first text and the second text is equal to or less than a designated value (e.g., a threshold), the processor 120 may output, as a speech recognition result, the second text instead of the first text. That is, if there is almost no difference between the first text and the second text, the processor 120 may correct the speech-recognized first text into the second text, and output the corrected second text as a speech recognition result. Alternatively, if the difference between the first text and the second text exceeds the designated value (e.g., the threshold), the processor 120 may output the first text as a speech recognition result. That is, if the difference between the first text and the second text is too large, the processor 120 may output the speech-recognized first text as a voice recognition result.

According to an embodiment, if the difference between the first text and the second text is equal to or less than the designated value (e.g., the threshold), the processor 120 may determine a relationship between the first text and the second text to be an utterance characteristic of the user. The processor 120 may add the relationship between the first text and the second text to information on the utterance characteristic of the user.

According to an embodiment, the processor 120 may acquire training data for recognition of the user's speech, based on relevance between the first text and the second text with respect to the speech data. For example, if the difference between the first text and the second text is equal to or less than the designated value, the processor 120 may acquire training data for recognition of speech data as the second text instead of the first text. The processor 120 may store the acquired training data in a storage device (e.g., the memory 130 and/or cache).

According to an embodiment, when training data is accumulated by a designated amount, the processor 120 may update a feature vector analysis model for recognizing the user's speech, based on the training data. Then, the processor 120 may perform training on the feature vector analysis model.

According to an embodiment, the neural processing unit (NPU) 125 may perform at least part of the aforementioned operations of the processor 120. Operations performed by the NPU 125 may be the same as or similar to those of the processor 120 described above. For example, the NPU 125 may be implemented as a processor optimized for artificial intelligent training and execution.

According to an embodiment, the processor 120 may be connected to the communication network 180 via the communication module 170. The processor 120 may transmit data to or receive data from the server 190 via the communication network 180. For example, speech data received via the microphone 140 of the electronic device 101 may be transmitted to the server 190 (e.g., an intelligence server or a cloud server) via the communication network 180. The server 190 may perform speech recognition by ASR and/or NLU processing of the speech data received from the electronic device 101. A speech recognition result processed by the server 190 may include at least one task or speech output data, and the speech recognition result generated by the server 190 may be transmitted to the electronic device 101 via the communication network 180. Detailed examples of a specific speech recognition procedure performed by the electronic device 101 or the server 190 and speech recognition results will be described later.

According to various embodiments, a result of speech recognition processed by the electronic device 101 or the server 190 may include text output data and/or speech output data. For example, text output data may be output via the display 160. Speech output data may be output via a speaker of the electronic device 101.

Operations of the electronic device 101 to be described below may be performed by at least one of the processor 120 and the NPU 125. However, for convenience of description, it will be described that the electronic device 101 performs the corresponding operations.

FIG. 2B is a flowchart illustrating acquiring of training data for speech recognition while performing speech recognition by an electronic device, according to an embodiment.

Referring to FIG. 2B, according to an embodiment, in operation 201, the electronic device 101 may acquire speech data corresponding to speech of a user.

According to an embodiment, in operation 203, the electronic device 101 may perform automatic speech recognition (ASR) and/or natural language understanding (NLU) so as to acquire first text by performing speech recognition on the speech data. For example, the first text may include text information transcribed into characters.

According to an embodiment, in operation 205, the electronic device 101 may identify second text stored in the memory 130, based on the first text. For example, the second text may include application information (e.g., an application name) and/or the user's personal information (e.g., information on contacts, schedules, locations, and times) pre-stored in the memory (130).

According to an embodiment, in operation 207, the electronic device 101 may output the first text or the second text as a result of speech recognition of the speech data, based on the difference between the first text and the second text. For example, the electronic device 101 may divide each of the first text and the second text into units of phonemes, and then identify differences between corresponding phonemes. If the difference between the first text and the second text is equal to or less than a threshold, the electronic device 101 may replace the first text with the second text, and output the second text as a speech recognition result. Alternatively, if the difference between the first text and the second text exceeds the threshold, the electronic device 101 may output the first text as a speech recognition result without replacing the first text with the second text.

According to an embodiment, in operation 209, the electronic device 101 may acquire training data for recognition of the user's speech, based on relevance between the first text and the second text with respect to the speech data. The electronic device 101 may store the training data in a storage device (e.g., the memory 130 and/or a cache area). The electronic device 101 may update a feature analysis model of the user's speech by using the stored training data. Thereafter, the electronic device 101 may learn the updated feature analysis model so as to perform speech recognition suitable for a feature of the user.

The electronic device 101 may perform operation 209 after operation 207 or concurrently with operation 207. Alternatively, the electronic device 101 may perform operation 209 before performing operation 207.

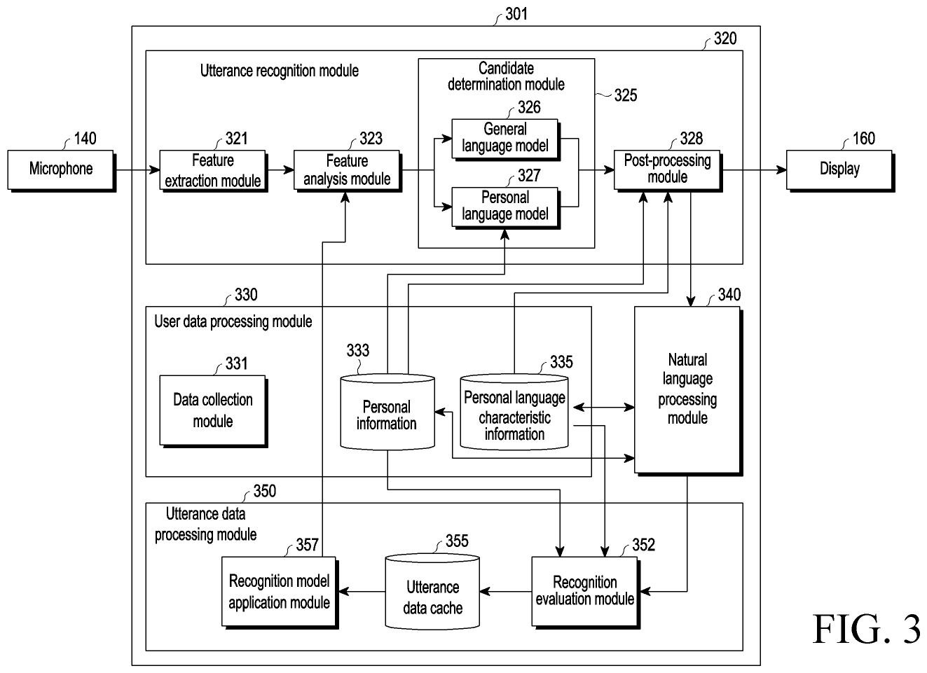

FIG. 3 is a block diagram illustrating a configuration of an electronic device performing speech recognition, according to an embodiment.

Referring to FIG. 3, the electronic device 101 may perform a speech recognition function 301. For example, the speech recognition function 301 may be performed by an utterance recognition module 320, a user data processing module 330, a natural language processing module 340, and an utterance data processing module 350.

According to an embodiment, the utterance recognition module 320 may receive speech data (or speech signal) from the microphone 140, perform speech recognition, and output or display a speech recognition result on the display 160.

According to an embodiment, the utterance recognition module 320 may include a feature extraction module 321, a feature analysis module 323, a candidate determination module 325, and a post-processing module 328.

According to an embodiment, the feature extraction module (or feature extractor) 321 may receive speech data from the microphone 140. For example, the feature extraction module 321 may extract a feature vector suitable for recognition from the speech data. The feature analysis module (or feature analyzer) 323 may analyze a feature vector extracted using a speech recognition model and determine speech recognition candidates, based on an analysis result. For example, the speech recognition model may include a general speech recognition model and a speech recognition model reflecting a characteristic of a user. The candidate determination module (or N-best generator) 325 may determine at least one recognition candidate from among multiple recognition candidates in order of high recognition probability. The candidate determination module 325 may determine at least one recognition candidate by using a general language model 326 and a personal language model 327. For example, the general language model 326 is obtained by modeling of general characteristics of language, wherein a recognition probability may be calculated by analyzing a relationship between a speech recognition unit and a word order of recognition candidates. The personal language model 327 is obtained by modeling of use information (e.g., personal information) stored in the electronic device 101, wherein a similarity between recognition candidates and the usage information may be calculated. The post-processing module 328 may determine at least one determined candidate as a speech recognition result, and output the determined speech recognition result to the display 160. In addition, the speech recognition result may be corrected and/or replaced using personal information stored in personal information database 333 and personal language characteristic information stored in personal language characteristic information database 335.

According to an embodiment, the user data processing module 330 may collect and process use information in the electronic device 101 so as to generate data necessary for post-processing and evaluation of a speech recognition result.

According to an embodiment, the user data processing module 330 may include a data collection module (or data collector) 331, the personal information database (or personal database) 333, and the personal language characteristic information database (or linguistic/practical database) 335.

According to an embodiment, the data collection module 331 may collect text information of contact information, a directory, application information, a schedule, and a location, and may classify the collected text information by category. The personal information database 333 may store and manage information included in a category enabling identification of individuals from among categories classified by the data collection module 331. The personal language characteristic information database 335 may store and manage data indicating characteristics of utterance, vocalization, and/or pronunciation of a user. For example, the personal language characteristic information database 335 may store information on a sentence structure for keyword extraction, grammar, utterance characteristics of a user, and a regional dialect.

According to an embodiment, the natural language processing module 340 may perform de-identification of a speech recognition result and training for correcting a speech recognition result. For example, the natural language processing module 340 may analyze a person's linguistic characteristic, such as a pronunciation characteristic and/or an utterance pattern of a user, via a speech recognition result. The natural language processing module 340 may store, in the personal language characteristic information database 335, a person's linguistic characteristic analyzed so that the post-processing module 328 corrects a speech recognition result. For example, if a speech recognition result is corrected from “Gaengju Cheomseungdae” to “Gyeongju Cheomseongdae” by using text information stored in the electronic device 101, the natural language processing module 340 may determine the relationship between “ [symbol] ” and “ [symbol] ” as utterance characteristics of a user. The natural language processing module 340 may learn the determined utterance characteristics of the user and may store information on the learned utterance characteristics of the user in the personal language characteristic information database 335.

According to an embodiment, the utterance data processing module 350 may store data necessary for learning a speech recognition model for an utterance characteristic of a user. In addition, the utterance data processing module 350 may train the speech recognition model for the utterance characteristic of the user.

According to an embodiment, the utterance data processing module 350 may include a recognition evaluation module (or recognition evaluator) 352, an utterance data cache (or speech data cache) 355, and a recognition model application module (or recognition model adapter) 357.

According to an embodiment, the recognition evaluation module 352 may determine a reliability of a speech recognition result, and determine whether to use the speech recognition result for learning according to a determination result. For example, the recognition evaluation module 352 may determine a reliability of a speech recognition result, based on the difference between speech data and transcribed text. In addition, the recognition evaluation module 352 may determine an evaluation result for the recognition result according to a difference (and reliability) between the speech data and the transcribed text, the difference being obtained based on information stored in the personal information database 333 and the personal language characteristic information database 225.

The utterance data cache 355 may store data including a set of texts transcribed into characters and speech data of a user. When a designated amount of data is stored, the utterance data cache 355 may transmit the stored data to the recognition model application module 357 so as to enable training of an utterance characteristic model of the user based on the stored data. Then, the utterance data cache 355 may delete all the stored data. The recognition model application module 357 may control training of an utterance characteristic model for recognizing speech of a user, based on data received from the utterance data cache 355.

According to an embodiment, the speech recognition function 301 may be performed by the electronic device 101. For example, the speech recognition function 301 may be performed by the processor 120. Depending on implementation, at least a part of the speech recognition function 301 may be performed by NPU 125. For example, the natural language processing module 340 and the utterance data processing module 350 may be executed by the NPU 125.

According to another embodiment, at least part of the speech recognition function 301 may be performed by the server 190 that establishes a communication connection to the electronic device 101. Depending on the implementation, operations of the utterance data processing module 350 may be performed by the server 190.

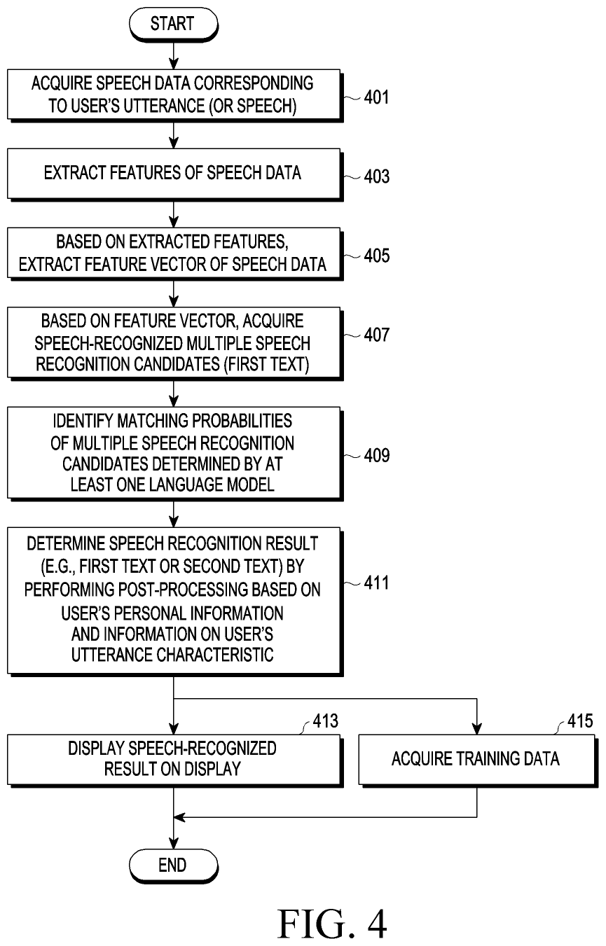

FIG. 4 is a flowchart illustrating performing speech recognition by an electronic device, according to an embodiment.

Referring to FIG. 4, according to an embodiment, in operation 401, the electronic device 101 may acquire speech data (or speech signal) corresponding to utterance (or speech) of a user via the microphone 140.

According to an embodiment, in operation 403, the electronic device 101 may extract features of the speech data. For example, the electronic device 101 may extract features of the speech data via the feature extraction module 321 executed in the electronic device 101.

According to an embodiment, in operation 405, the electronic device 101 may extract a feature vector of the speech data, based on the extracted features. For example, the electronic device 101 may extract the feature vector of the speech data via the feature analysis module 323 executed in the electronic device 101.

According to an embodiment, in operation 407, the electronic device 101 may acquire speech-recognized multiple speech recognition candidates, based on the feature vector. For example, the electronic device 101 may determine the multiple speech recognition candidates via the candidate determination module 325 executed in the electronic device 101. For example, each of the multiple speech recognition candidates may include text. For example, the multiple speech recognition candidates may include first text.

According to an embodiment, in operation 409, the electronic device 101 may identify matching probabilities of the multiple speech recognition candidates determined by at least one language model. For example, the electronic device 101 may determine the multiple speech recognition candidates via the candidate determination module 325 executed in the electronic device 101. For example, the electronic device 101 may list the multiple speech recognition candidates in order of recognition probability, and determine at least one speech recognition candidate included in a designated rank. For example, the at least one speech recognition candidate may include first text speech-recognized via the speech data.

According to an embodiment, in operation 411, the electronic device 101 may determine a speech recognition result (e.g., the first text or second text) by performing post-processing of at least one speech recognition candidate (e.g., the first text), based on personal information of the user and information on an utterance characteristic of the user. For example, the electronic device 101 may identify an utterance intent of the user by analyzing the first text. The electronic device 101 may search for or identify second text pre-stored in the memory 130, based on the utterance intent. For example, the electronic device 101 may correct or replace the speech recognition result by using the personal information database 333 and/or the personal language characteristic information database 335. For example, the electronic device 101 may correct a part (e.g., an error) of the first text or replace the first text with the second text. For example, the electronic device 101 may determine the speech recognition result, based on the difference between the first text and the second text stored in the memory 130. For example, in determination of the difference between the first text and the second text, the electronic device 101 may determine a weight according to the utterance characteristic of the user. The electronic device 101 may replace the first text with the second text if the difference equal to or is less than a threshold. Alternatively, if the difference exceeds the threshold, the electronic device 101 may not replace the first text with the second text. For example, the electronic device 101 may determine the speech recognition result via the post-processing module 328 executed in the electronic device 101. The electronic device 101 may also perform the aforementioned operations with respect to at least one speech recognition candidate in addition to the first text. Accordingly, the electronic device 101 may determine the speech recognition result.

According to an embodiment, in operation 413, the electronic device 101 may display the speech recognition result (the first text or the second text) on the display 160. Alternatively, the electronic device 101 may output sound indicating the speech recognition result via a speaker included in the electronic device 101.

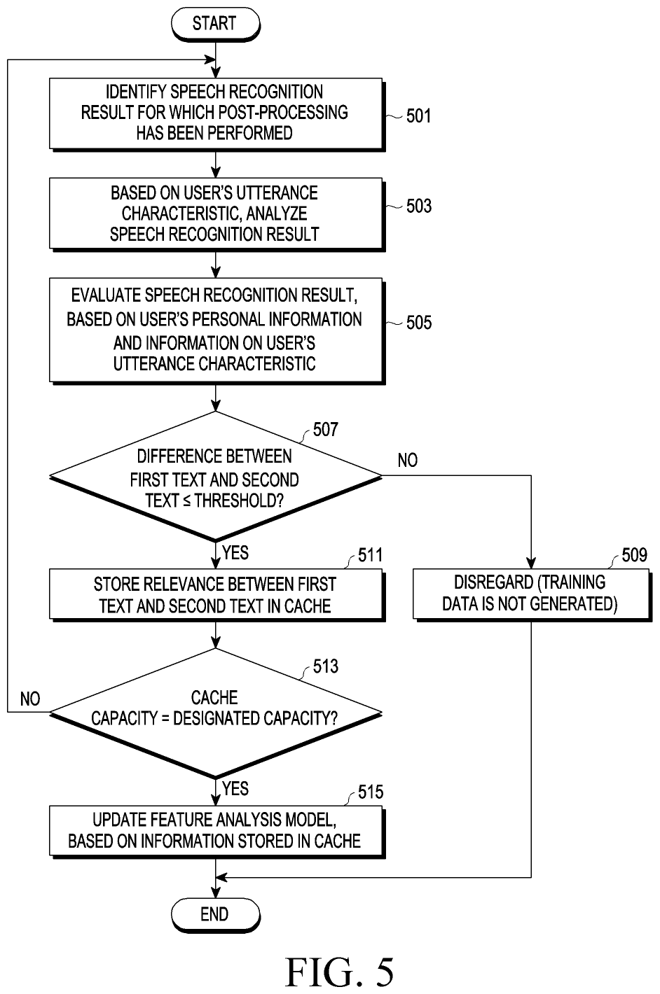

According to an embodiment, in operation 415, the electronic device 101 may acquire training data for recognition of the user's speech, based on the difference between the first text speech-recognized via the speech data and the second text stored in the memory 130. Acquiring of training data by the electronic device 101 will be described later with reference to FIG. 5.

Operation 415 may be performed after execution of operation 413 or may be performed concurrently with operation 413. Alternatively, operation 415 may be performed before execution of operation 413. However, the technical spirit of the disclosure may not be limited thereto.

FIG. 5 is a flowchart illustrating acquiring of training data for speech recognition by an electronic device, according to an embodiment.

Referring to FIG. 5, according to an embodiment, in operation 501, the electronic device 101 may identify a speech recognition result (e.g., the result value of the post-processing module 328 of FIG. 3) for which post-processing operation been performed.

According to an embodiment, in operation 503, the electronic device 101 may analyze the speech recognition result (e.g., first text or second text), based on an utterance characteristic of a user. For example, the electronic device 101 may acquire information on the utterance characteristic of the user from the personal language characteristic information database 335. The electronic device 101 may identify the user's utterance characteristic or utterance pattern (e.g., a combination of sentences that can be spoken) by analyzing a sentence structure of the speech recognition result. In addition, the electronic device 101 may store information on the identified utterance characteristic or utterance pattern in the personal language characteristic information database 335.

According to an embodiment, in operation 505, the electronic device 101 may evaluate the speech recognition result, based on personal information of the user and information on the utterance characteristic of the user. For example, if the first text is replaced with the second text, the electronic device 101 may determine the utterance characteristic of the user, based on relevance between the first text and the second text. In addition, the electronic device 101 may store information on the relevance between the first text and the second text in the personal language characteristic information database 335.

According to an embodiment, in operation 507, the electronic device 101 may compare the difference between the first text and the second text with a threshold. For example, the electronic device 101 may determine whether a value corresponding to the difference is equal to or less than the threshold. For example, the value corresponding to the difference may be a value obtained by applying a weight to differences between phonemes (e.g., consonants and vowels) included in the first text and phonemes (e.g., consonants and vowels) included in the second text.

According to an embodiment, if it is identified that the difference between the first text and the second text exceeds the threshold (No in operation 507), the electronic device 101 may disregard the speech recognition result in operation 509. For example, the electronic device 101 may not generate training data by using the speech recognition result.

According to an embodiment, if it is identified that the difference between the first text and the second text does not exceed the threshold (Yes in operation 507), the electronic device 101 may store, as training data, the relevance between the first text and the second text in a cache (e.g., the speech data cache of FIG. 3) in operation 511.

According to an embodiment, in operation 513, the electronic device 101 may identify whether a cache capacity has reached a designated capacity. For example, the designated capacity may be automatically configured by the electronic device 101 or may be configured by the user. If it is identified that the cache capacity has not reached the designated capacity (No in operation 513), the electronic device 101 may acquire and store training data until the cache capacity reaches the designated capacity.

According to an embodiment, if it is identified that the cache capacity has reached the designated capacity (Yes in operation 513), the electronic device 101 may update a feature analysis model in operation 515, based on information stored in the cache. When the feature analysis model is updated, the electronic device 101 may learn the updated feature analysis model. Accordingly, the electronic device 101 may perform speech recognition by considering the utterance characteristic of the user.

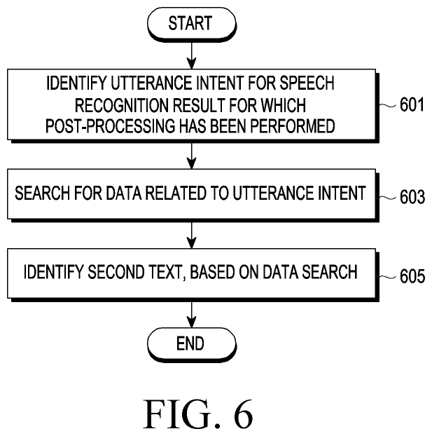

FIG. 6 is a flowchart illustrating acquiring of second text stored in a memory by identifying an utterance intent in speech data by an electronic device, according to an embodiment.

Referring to FIG. 6, according to an embodiment, in operation 601, the electronic device 101 may identify an utterance intent of a user with respect to a speech recognition result (e.g., the result value of the post-processing module 328 of FIG. 3, for example, the first text) for which post-processing has been performed.

According to an embodiment, in operation 603, the electronic device 101 may search for data (e.g., data including text) related to the utterance intent from among data stored in the memory 130. For example, the electronic device 101 may identify a category related to the utterance intent. For example, if the utterance intent is making a call, the electronic device 101 may search for data (e.g., data including text) related to contact information.

According to an embodiment, in operation 605, the electronic device 101 may identify the second text, based on the data search. For example, if the utterance intent is making a call, the electronic device 101 may identify the second data identical to or similar to the first text, from contact information data. Accordingly, the electronic device 101 may efficiently search for data related to the first text, which is stored in the memory 130. For example, the electronic device 101 may reduce resources consumed for the data search and reduce time required for the data search.

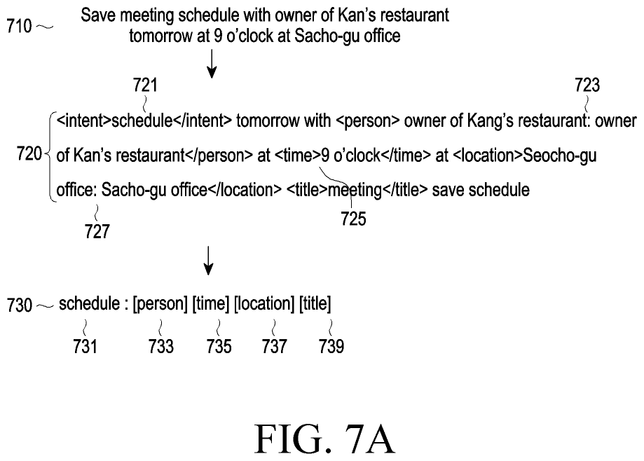

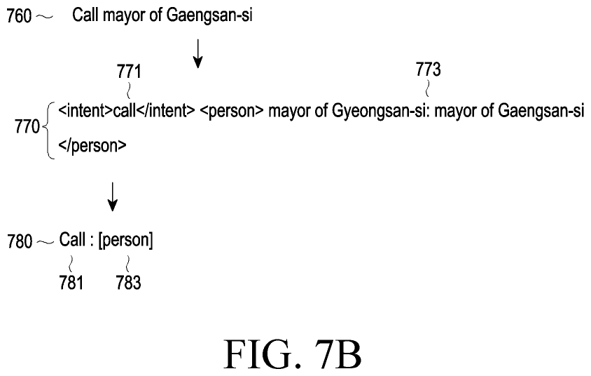

FIG. 7A and FIG. 7B are diagrams illustrating identifying of an utterance intent in speech data by an electronic device, according to an embodiment.

Referring to FIG. 7A, the electronic device 101 according to an embodiment may acquire first text 710 obtained by speech recognition of speech data. For example, the first text 710 may be “Save a meeting schedule with the owner of Kan's restaurant tomorrow at 9 o'clock at Sacho-gu office”.

The electronic device 101 according to an embodiment may identify a speech recognition result 720 obtained by performing post-processing on the first text 710. For example, the electronic device 101 may classify the first text 710 according to an utterance intent (e.g., schedule) 721, a person 723, a time 725, a location 727, and a title 729. For example, the speech recognition result 720 may be “<intent>schedule</intent> tomorrow with <person>the owner of Kang's restaurant: the owner of Kan's restaurant</person> at <time>9 o'clock</time> at <location>Seocho-gu office: Sacho-gu office<location> <title>meeting</title> save schedule”. In the first text 710, the electronic device 101 may change or replace “the owner of Kan's restaurant”, based on the second text (e.g., the owner of Kang's restaurant) pre-stored in the memory 130. In addition, in the first text 710, the electronic device 101 may change or replace “Sacho-gu office”, based on the second text (e.g., Seocho-gu office) pre-stored in the memory 130.

The electronic device 101 according to an embodiment may analyze a sentence structure of the speech recognition result 720, based on personal language characteristic information received from the personal language characteristic information database 335. For example, the electronic device 101 may identify that the speech recognition result 720 has a sentence structure including an utterance intent 731, a person 733, a time 735, a location 737, and a title 739. The electronic device 101 may store information 730 on the analyzed sentence structure in the personal language characteristic information database 335.

Referring to FIG. 7B, the electronic device 101 according to an embodiment may acquire first text 760 obtained by speech recognition of speech data. For example, the first text 760 may be, “Call the mayor of Gaengsan-si”.

The electronic device 101 according to an embodiment may identify a speech recognition result 770 obtained by performing post-processing on the first text 760. For example, the electronic device 101 may classify the first text 760 according to an utterance intent (e.g., making a call) 771 and a person 773. For example, the speech recognition result 770 may be “<intent>call</intent> <person> the mayor of Gyeongsan-si: the mayor of Gaengsan-si</person>”. In the first text 760, the electronic device 101 may change or replace “the mayor of Gaengsan-si”, based on the second text (e.g., the mayor of Gyeongsan-si) pre-stored in the memory 130.

The electronic device 101 according to an embodiment may analyze a sentence structure of the speech recognition result 720, based on personal language characteristic information received from the personal language characteristic information database 335. For example, the electronic device 101 may identify that the speech recognition result 720 has a sentence structure including an utterance intent 781 and a person 783. The electronic device 101 may store information 780 on the analyzed sentence structure in the personal language characteristic information database 335.

According to the aforementioned method, the electronic device 101 may correct or replace the speech-recognized first text, based on the second text stored in the memory 130. In addition, the electronic device 101 may use information on a result of correction or replacement (e.g., relevance between the first text and the second text) as training data.

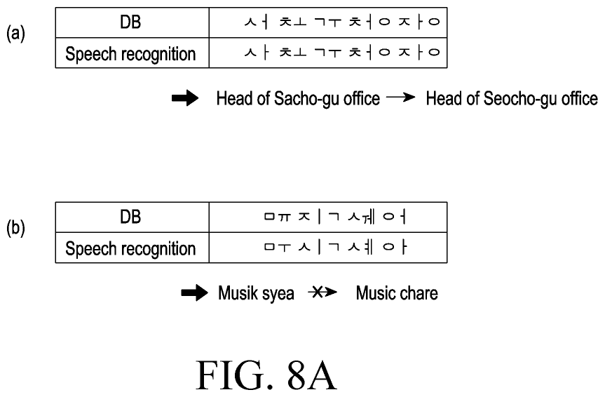

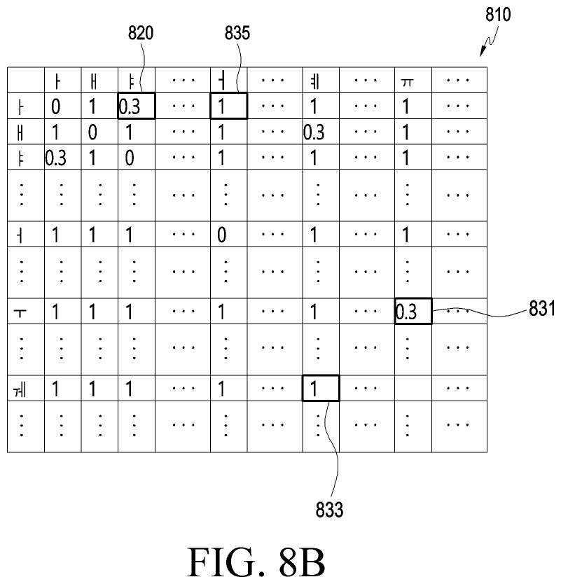

FIG. 8A shows diagrams illustrating correcting of first text obtained by speech recognition, based on second text stored in the memory of an electronic device, and using the same, according to an embodiment. FIG. 8B is a table showing weights for identifying, by the electronic device, whether the difference between first text and second text is equal to or less than a threshold, according to an embodiment.

Referring to FIGS. 8A and 8B, according to an exemplary embodiment, the electronic device 101 may identify the difference between first text and second text which are obtained by speech recognition of speech data. For example, referring to FIG. 8B, a value 820 corresponding to the difference between “ [symbol] ” and “ [symbol] ” may be 0.3. A value corresponding to the difference between “ [symbol] ” and “ [symbol] ” may be 0.

Referring to (a) of FIG. 8A, according to an embodiment, speech-recognized first text may be “the head of Sacho-gu office”, and second text stored in the memory 130 or a database (DB) (e.g., contact information) may be “the head of Seocho-gu office”. The electronic device 101 may divide the first text and the second text into units of phonemes (e.g., vowels and consonants). The electronic device 101 may compare the first text and the second text which are divided in units of phonemes. For example, the difference between the first text and the second text may be “ [symbol] ” and “ [symbol] ”. According to FIG. 8B, the electronic device 101 may determine a weight 835 (e.g., 1) between “ [symbol] ” and “ [symbol] ”. Since there is no difference between the remaining phonemes, the electronic device 101 may determine the weight to be 0. The electronic device 101 may determine the sum of all weights between the first text and the second text. Accordingly, the electronic device 101 may identify the value corresponding to the difference between the first text and the second text to be “1”.

According to an embodiment, the electronic device 101 may identify a threshold, based on Equation 1. For example, since the number of phonemes in [symbol] (the head of Sacho-gu office) (or [symbol] (the head of Seocho-gu office)) is 12, a threshold may be 2.4.

Threshold=number of phonemes*0.2 (designated configuration value) [Equation 1]

According to an embodiment, a value corresponding to the difference between “the head of Sacho-gu office” and “the head of Seocho-gu office” may be smaller than the threshold. The electronic device 101 may correct “the head of Sacho-gu office” to “the head of Seocho-gu office”. That is, the electronic device 101 may replace “ [symbol] ” with “ [symbol] ”.

According to an embodiment, the electronic device 101 may acquire training data for recognition of the user's speech, based on relevance between “the head of Sacho-gu office” and “the head of Seocho-gu office”. For example, the electronic device 101 may determine information on the relevance between “the head of Sacho-gu office” and “the head of Seocho-gu office” as an utterance characteristic of the user. The electronic device 101 may store information on the relevance between “the head of Sacho-gu office” and “the head of Seocho-gu office” in a cache (e.g., the utterance data cache 355 of FIG. 3). That is, if the difference between the first text and the second text is within a threshold range, the electronic device 101 may use the relevance as training data.

Referring to (b) of FIG. 8A, according to an embodiment, speech-recognized first text may be “musik syea”, and second text stored in the memory 130 or a database (DB) (e.g., application name) may be “music share”. The electronic device 101 may divide the first text and the second text into units of phonemes (e.g., vowels and consonants). The electronic device 101 may compare the first text and the second text which are divided in units of phonemes. For example, the differences between the first text and the second text may be “ [symbol] ” and “ [symbol] ”, “ [symbol] ” and “ [symbol] ”, “ [symbol] ” and “ [symbol] ”, and “ [symbol] ” and “ [symbol] ”. According to FIG. 8B, the electronic device 101 may identify a weight 831 (e.g., 0.3) between “ [symbol] ” and “ [symbol] ”, a weight (e.g., 1) between “ [symbol] ” and “ [symbol] ”, a weight 833 (e.g., 1) between “ [symbol] ” and “ [symbol] ”, and a weight (e.g., 1) between “ [symbol] ” and “ [symbol] ”. The electronic device 101 may identify the difference between the remaining phonemes to be 0. The electronic device 101 may determine the sum of all weights between the first text and the second text. Accordingly, the electronic device 101 may identify the value corresponding to the difference between the first text and the second text to be “3.3”.

According to an embodiment, the electronic device 101 may identify a threshold, based on Equation 1. For example, since the number of phonemes in musik syea [symbol] (musik syea) (or [symbol] ) (music share)) is 9, a threshold may be 1.8.

According to an embodiment, a value corresponding to the difference between “musik syea” and “music share” may be greater than the threshold. The electronic device 101 may not correct or replace “musik syea” with “music share”.

According to an embodiment, the electronic device 101 may determine that there is no relevance between “musik syea” and “music share”. The electronic device 101 may not acquire training data for recognition of the user's speech, based on the difference or relevance between “musik syea” and “music share”. That is, the electronic device 101 may use the relevance as training data only if the difference between the first text and the second text is within a threshold range.

The weights of FIG. 8B are merely exemplary for convenience of description, and the technical spirit of the disclosure may not be limited thereto. In addition, although only a table for weights between vowels is illustrated in FIG. 8B, a table for weights between consonants may also be implemented similarly to the table in FIG. 8B. However, for convenience of description, a table of weights between consonants will be omitted. In addition, weights between consonants and vowels of languages other than Korean may also be implemented similarly to the table in FIG. 8B.

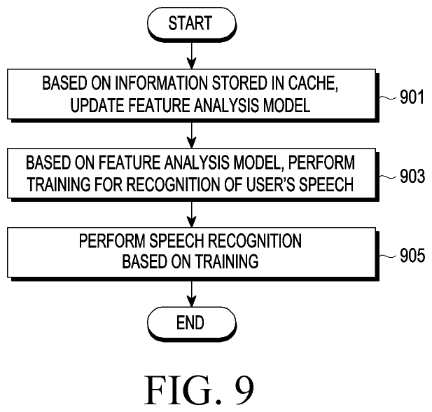

FIG. 9 is a flowchart illustrating performing training for recognizing a user's speech by updating a feature analysis model by an electronic device, according to an embodiment.

Referring to FIG. 9, according to an embodiment, in operation 901, the electronic device 101 may update a feature analysis model (e.g., the feature analysis module 323 of FIG. 3), based on information stored in a cache. For example, when the amount of information stored in the cache reaches a designated capacity, the electronic device 101 may update the feature analysis model, based on the information stored in the cache. For example, information reflecting an utterance characteristic and/or an utterance pattern of a user may be updated in the feature analysis model.

According to an embodiment, in operation 903, the electronic device 101 may perform training for recognizing speech of the user, based on the updated feature analysis model. The electronic device 101 may learn the utterance characteristic and/or utterance pattern of the user via the updated feature analysis model.

According to an embodiment, in operation 905, the electronic device 101 may perform speech recognition by considering the utterance characteristic and/or utterance pattern of the user, based on training. Accordingly, the electronic device 101 may increase accuracy of speech recognition. In addition, even without separately requiring acquisition of training data from a user, the electronic device 101 may conveniently acquire training data.

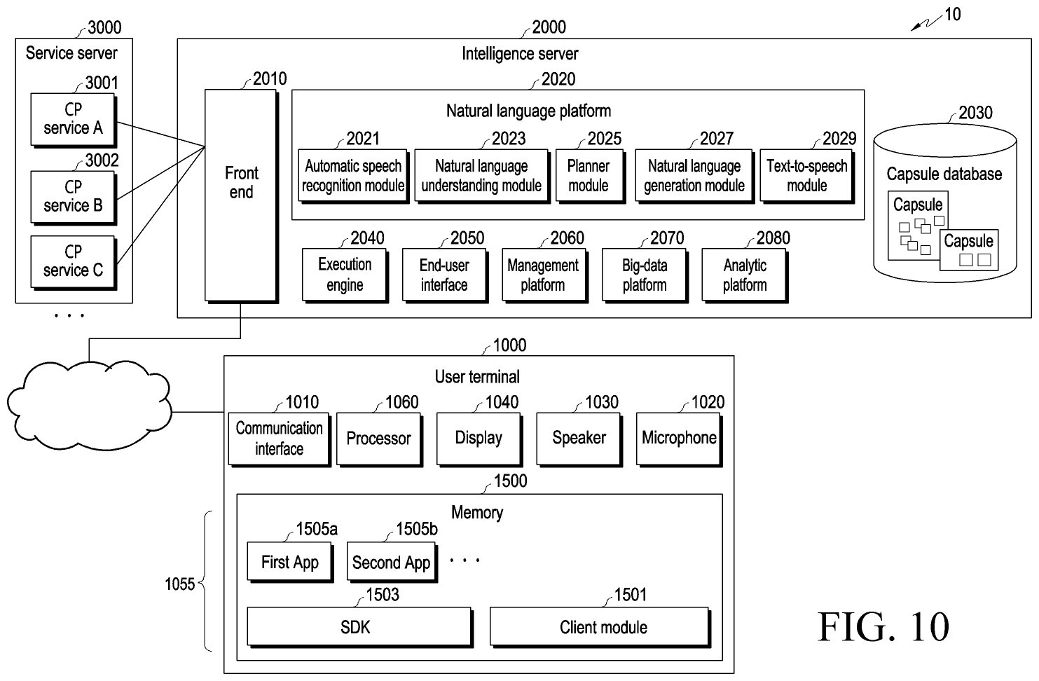

At least some of the aforementioned operations may be performed by the server 190 according to FIGS. 10-12. The server 190 may be implemented identically or similarly to a server (reference numeral 2000 and/or reference numeral 3000 of FIG. 10) below. In addition, the electronic device 101 may be implemented identically or similarly to a user terminal 1000 of FIG. 10.

FIG. 10 is a block diagram illustrating an integrated intelligence system, according to an embodiment.

Referring to FIG. 10, an integrated intelligence system 10 according to an embodiment may include the user terminal 1000, an intelligence server 2000, and a service server 3000.

The user terminal 1000 according to an embodiment may be a terminal device (or electronic device) capable of connecting to the Internet, and may be, for example, a mobile phone, a smartphone, a personal digital assistant (PDA), a notebook computer, a TV, a home appliance, a wearable device, an HMD, or a smart speaker.

According to the illustrated embodiment, the user terminal 1000 may include a communication interface 1010, a microphone 1020, a speaker 1030, a display 1040, a memory 1050, or a processor 1060. The elements listed above may be operatively or electrically connected to each other.

The communication interface 1010 of an embodiment may be configured to be connected to an external device so as to transmit or receive data. The microphone 140 of an embodiment may receive sound (e.g., a user's utterance) and convert the sound into an electrical signal. The speaker 1030 of an embodiment may output an electrical signal as sound (e.g., speech). The display 1040 of an embodiment may be configured to display an image or a video. The display 1040 of an embodiment may also display a graphic user interface (GUI) of a running app (or an application program).

The memory 1050 of an embodiment may store a client module 1051, a software development kit (SDK) 1053, and multiple apps 1055. The client module 1051 and the SDK 1053 may constitute a framework (or a solution program) for performing general-purpose functions. In addition, the client module 1051 or the SDK 1053 may configure a framework for processing a speech input.

In the memory 1050 of an embodiment, the multiple apps 1055 may be programs for performing designated functions. According to an embodiment, the multiple apps 1055 may include a first app 1055a and a second app 1055b. According to an embodiment, each of the multiple apps 1055 may include multiple operations for performing designated functions. For example, the apps may include an alarm app, a message app, and/or a schedule application. According to an embodiment, the multiple apps 1055 may be executed by the processor 1060 to sequentially execute at least some of the multiple operations.

The processor 1060 according to an embodiment may control overall operations of the user terminal 1000. For example, the processor 1060 may be electrically connected to the communication interface 1010, the microphone 1020, the speaker 1030, and the display 1040 so as to perform designated operations.

The processor 1060 of an embodiment may also execute a program stored in the memory 1050 so as to perform a designated function. For example, the processor 1060 may execute at least one of the client module 1051 and the SDK 1053 so as to perform the following operations for processing a speech input. The processor 1060 may control, for example, operations of the multiple apps 1055 via the SDK 1053. The following operations described as operations of the client module 1051 or the SDK 1053 may be operations performed by the processor 1060.

The client module 1051 of an embodiment may receive a speech input. For example, the client module 1051 may receive a speech signal corresponding to a user's utterance detected via the microphone 1020. The client module 1051 may transmit the received speech input to the intelligence server 2000. The client module 1051 may transmit the received speech input and state information of the user terminal 1000 to the intelligence server 2000. The state information may be, for example, execution state information of an app.

The client module 1051 of an embodiment may receive a result corresponding to the received speech input. For example, when the intelligence server 2000 is able to calculate the result corresponding to the received speech input, the client module 1051 may receive the result corresponding to the received speech input. The client module 1051 may display the received result on the display 1040.

The client module 1051 of an embodiment may receive a plan corresponding to the received speech input. The client module 1051 may display, on the display 1040, results of executing multiple operations of an app according to the plan. The client module 1051 may sequentially display, for example, the results of executing the multiple operations on the display. For another example, the user terminal 1000 may display only some of the results of executing the multiple operations (e.g., a result of the last operation) on the display.

According to an embodiment, the client module 1051 may receive a request for acquiring information necessary for calculating a result corresponding to the speech input from the intelligence server 2000. According to an embodiment, the client module 1051 may transmit the necessary information to the intelligence server 2000 in response to the request.

The client module 1051 of an embodiment may transmit, to the intelligence server 2000, information on the results of executing the multiple operations according to the plan. The intelligence server 2000 may identify that the received speech input has been properly processed using the result information.

The client module 1051 of an embodiment may include a speech recognition module. According to an embodiment, the client module 1051 may recognize, via the speech recognition module, a speech input for execution of a limited function. For example, the client module 1051 may execute an intelligence app for processing a speech input to perform an organic operation via a designated input (e.g., wake up!).

The intelligence server 2000 of an embodiment may receive information related to a speech input of a user from the user terminal 1000 via a communication network. According to an embodiment, the intelligence server 2000 may change data related to the received speech input into text data. According to an embodiment, the intelligence server 2000 may generate a plan for performing a task corresponding to the speech input of the user, based on the text data.

According to an embodiment, the plan may be generated by an artificial intelligent (AI) system. The artificial intelligence system may be a rule-based system, and may be a neural network-based system (e.g., a feedforward neural network (FNN)) or a recurrent neural network (RNN). Alternatively, the artificial intelligent system may be a combination of the above or other artificial intelligent systems. According to an embodiment, the plan may be selected from a predefined set of plans, or may be generated in real time in response to a user request. For example, the artificial intelligent system may select at least one plan from multiple predefined plans.

The intelligence server 2000 of an embodiment may transmit a result according to the generated plan to the user terminal 100, or transmit the generated plan to the user terminal 1000. According to an embodiment, the user terminal 1000 may display a result according to the plan on the display. According to an embodiment, the user terminal 1000 may display, on the display, a result of executing an operation according to the plan.

The intelligence server 2000 of an embodiment may include a front end 2010, a natural language platform 2020, a capsule database (DB) 2030, an execution engine 2040, an end-user interface 2050, a management platform 2060, a big-data platform 2070, or an analytic platform 2080.

The front end 2010 of an embodiment may receive a speech input received from the user terminal 1000. The front end 2010 may transmit a response corresponding to the speech input.

According to an embodiment, the natural language platform 2020 may include an automatic speech recognition module (ASR module) 2021, a natural language understanding module (NLU module) 2023, a planner module (planner module) 2025, a natural language generator module (NLG module) 2027, or a text-to-speech module (TTS module) 2029.

The automatic speech recognition module 2021 of an embodiment may convert a speech input received from the user terminal 1000 into text data. The natural language understanding module 2023 of an embodiment may determine a user's intent by using text data of a speech input. For example, the natural language understanding module 2023 may determine the user's intent by performing syntactic analysis or semantic analysis. The natural language understanding module 2023 of an embodiment may identify the meaning of a word extracted from the speech input by using a linguistic feature (e.g., a grammatical element) of a morpheme or phrase, and may determine the user's intent by matching the identified meaning of the word to the intent.

The planner module 2025 of an embodiment may generate a plan by using an intent and a parameter determined by the natural language understanding module 2023. According to an embodiment, the planner module 2025 may determine multiple domains necessary for performing a task, based on the determined intent. The planner module 2025 may determine multiple operations included in the respective multiple domains determined based on the intent. According to an embodiment, the planner module 2025 may determine parameters necessary for executing the determined multiple operations, or result values output by execution of the multiple operations. The parameters and the result values may be defined as concepts of designated formats (or classes). Accordingly, the plan may include multiple concepts and multiple operations determined by the user's intent. The planner module 2025 may determine relationships between the multiple operations and the multiple concepts in stages (or hierarchically). For example, the planner module 2025 may determine, based on the multiple concepts, an execution sequence of the multiple operations determined based on the user's intent. In other words, the planner module 2025 may determine an execution sequence of the multiple operations, based on parameters necessary for execution of the multiple operations and results output by execution of the multiple operations. Accordingly, the planner module 2025 may generate a plan including association information (e.g., ontology) between the multiple concepts, and the multiple operations. The planner module 2025 may generate a plan by using information stored in the capsule database 2030 in which a set of relationships between the concepts and operations is stored.

The natural language generation module 2027 of an embodiment may change designated information into a text form. The information changed into the text form may be a form of a natural language utterance. The text-to-speech module 2029 of an embodiment may change information in a text form to information in a speech form.

According to an embodiment, some functions or all functions of the natural language platform 2020 can be implemented also in the user terminal 1000.

The capsule database 2030 may store information on relationships between multiple concepts and operations corresponding to multiple domains. A capsule according to an embodiment may include multiple operation objects (action objects or action information) and concept objects (concept objects or concept information) included in a plan. According to an embodiment, the capsule database 2030 may store multiple capsules in the form of a concept action network (CAN). According to an embodiment, multiple capsules may be stored in a function registry included in the capsule database 230.

The capsule database 2030 may include a strategy registry in which strategy information necessary for determining a plan corresponding to a speech input is stored. The strategy information may include reference information for determination of one plan if there are multiple plans corresponding to the speech input. According to an embodiment, the capsule database 2030 may include a follow-up registry which stores information on a follow-up action for suggesting a follow-up action to a user in a designated situation. The follow-up action may include, for example, follow-up utterance. According to an embodiment, the capsule database 2030 may include a layout registry which stores layout information of information output via the user terminal 1000. According to an embodiment, the capsule database 2030 may include a vocabulary registry which stores vocabulary information included in capsule information. According to an embodiment, the capsule database 2030 may include a dialog registry which stores information on a dialog (or interaction) with a user. The capsule database 2030 may update a stored object via a developer tool. The developer tool may include, for example, a function editor for updating an action object or a concept object. The developer tool may include a vocabulary editor for updating vocabulary. The developer tool may include a strategy editor which generates and registers a strategy for determining a plan. The developer tool may include a dialog editor which generates a dialog with a user. The developer tool may include a follow-up editor capable of activating a follow-up goal and editing follow-up utterance that provide a hint. The follow-up goal may be determined based on a currently configured goal, a user's preference, or an environmental condition. In an embodiment, the capsule database 2030 may also be able to be implemented in the user terminal 1000.

The execution engine 2040 of an embodiment may calculate a result by using a generated plan. The end-user interface 2050 may transmit the calculated result to the user terminal 1000. Accordingly, the user terminal 1000 may receive the result and provide the received result to a user. The management platform 2060 of an embodiment may manage information used in the intelligence server 2000. The big-data platform 2070 of an embodiment may collect user data. The analytic platform 2080 of an embodiment may manage a quality of service (QoS) of the intelligence server 2000. For example, the analytic platform 2080 may manage the elements and processing speed (or efficiency) of the intelligence server 2000.

The service server 3000 of an embodiment may provide a designated service (e.g., ordering food or making a hotel reservation) to the user terminal 1000. According to an embodiment, the service server 3000 may be a server operated by a third party. The service server 3000 of an embodiment may provide the intelligence server 2000 with information for generation of a plan corresponding to a received speech input. The provided information may be stored in the capsule database 2030. In addition, the service server 3000 may provide result information according to the plan to the intelligence server 2000.

In the integrated intelligence system 10 described above, the user terminal 1000 may provide various intelligent services to a user in response to a user input. The user input may include, for example, an input via a physical button, a touch input, or a speech input.

In an embodiment, the user terminal 1000 may provide a speech recognition service via an internally stored intelligence app (or a speech recognition application). In this case, for example, the user terminal 1000 may recognize a user's utterance or speech input (voice input) received via the microphone, and provide a service corresponding to the recognized speech input to the user.

In an embodiment, the user terminal 1000 may perform a designated operation alone or together with the intelligence server and/or the service server, based on a received speech input. For example, the user terminal 1000 may execute an app corresponding to the received speech input, and perform a designated operation via the executed app.

In an embodiment, if the user terminal 1000 provides a service with the intelligence server 2000 and/or the service server 3000, the user terminal 100 may detect utterance of a user by using the microphone 1020 and generate a signal (or speech data) corresponding to the detected utterance of the user. The user terminal 1000 may transmit the speech data to the intelligence server 2000 by using the communication interface 1010.

The intelligence server 2000 according to an embodiment may generate, as a response to the speech input received from the user terminal 1000, a plan for performing a task corresponding to the speech input or a result of performing an operation according to the plan. The plan may include, for example, multiple operations for performing a task corresponding to the speech input of the user, and multiple concepts related to the multiple operations. The concepts may be obtained by defining parameters input to execution of the multiple operations or result values output by execution of the multiple operations. The plan may include association information between the multiple operations and the multiple concepts.

The user terminal 1000 of an embodiment may receive the response by using the communication interface 1010. The user terminal 1000 may output a speech signal generated inside the user terminal 1000 to the outside by using the speaker 1030, or output an image generated inside the user terminal 1000 to the outside by using the display 1040.

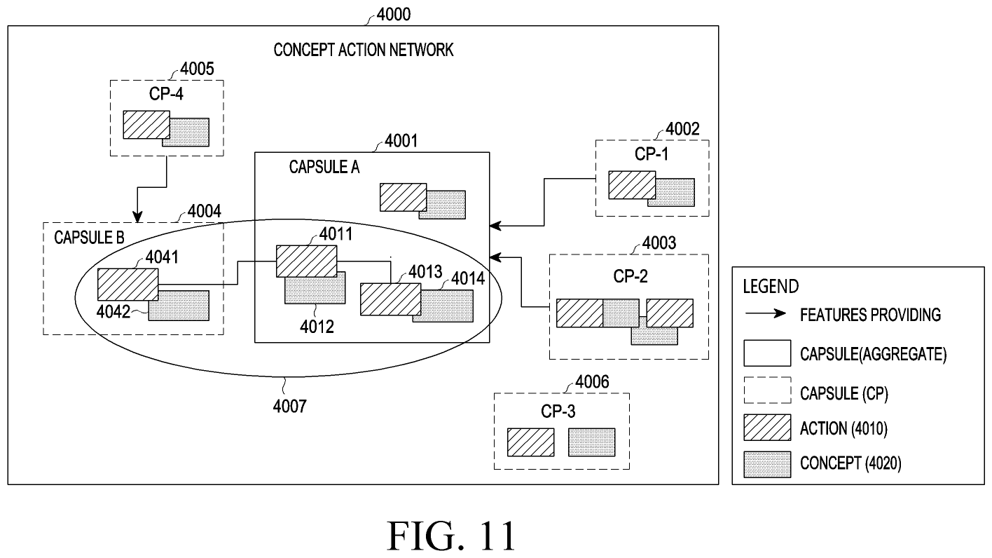

FIG. 11 is a diagram illustrating association information between an action concept and an action stored in a database, according to an embodiment.

A capsule database (e.g., the capsule database 2030) of the intelligence server 2000 may store a capsule in the form of a concept action network (CAN) 4000. The capsule database may store, in the form of the concept action network (CAN) 4000, an action for processing a task corresponding to a speech input of a user and a parameter necessary for the action.

The capsule database may store multiple capsules (capsule A 4001 and capsule B 4004) corresponding to respective multiple domains (e.g., applications). According to an embodiment, one capsule (e.g., capsule A 4001) may correspond to one domain (e.g., location (geo), application). In addition, one capsule may correspond to at least one service provider (e.g., CP-1 4002, CP-2 4003, CP-3 4006, or CP-4 4005) for performing a function for a domain related to the capsule. According to an embodiment, a capsule may include at least one concept and at least one action for performing a designated function.

The natural language platform 2020 may generate a plan for performing a task corresponding to a received speech input by using a capsule stored in the capsule database. For example, the planner module 2025 of the natural language platform may generate a plan by using a capsule stored in the capsule database. For example, plan 4007 may be generated using actions 4011 and 4013 and concepts 4012 and 4014 of capsule A 4001 and operation 4041 and concept 4042 of capsule B 4004.

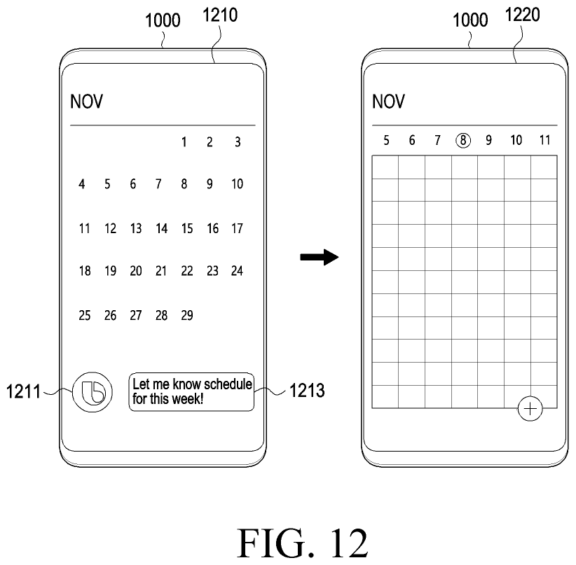

FIG. 12 is a diagram illustrating a user terminal which displays a screen for processing of a speech input received via an intelligence app, according to an embodiment.

The user terminal 1000 may execute an intelligence app to process a user input via the intelligence server 2000.

According to an embodiment, on screen 1210, when the user terminal 1000 recognizes a designated speech input (e.g., wake up!) or receives an input via a hardware key (e.g., dedicated hardware key), the user terminal 1000 may execute an intelligence app for processing the speech input. The user terminal 1000 may execute the intelligent app for processing the speech input. According to an embodiment, the user terminal 1000 may display an object (e.g., icon) 1211 corresponding to the intelligent app on the display 1040. According to an embodiment, the user terminal 1000 may receive a speech input caused by utterance of a user. For example, the user terminal 1000 may receive a speech input of “Let me know the schedule for this week!”. According to an embodiment, the user terminal 1000 may display, on the display, a user interface (UI) 1213 (e.g., an input window) of the intelligence app, which displays text data of the received speech input.

According to an embodiment, on screen 1220, the user terminal 1000 may display, on the display, a result corresponding to the received speech input. For example, the user terminal 1000 may receive a plan corresponding to the received user input and display “the schedule for this week” on the display according to the plan.

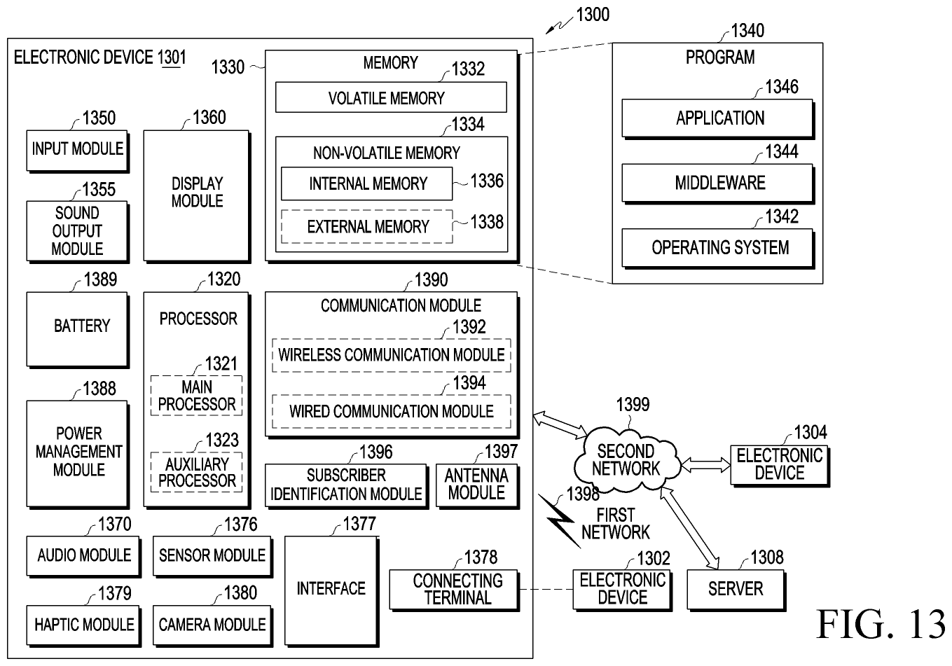

The electronic devices 101 and 1000 may be implemented identically or similarly to an electronic device 1301 of FIG. 13 below.

FIG. 13 is a block diagram illustrating an electronic device 1301 in a network environment 1300 according to various embodiments. Referring to FIG. 13, the electronic device 1301 in the network environment 1300 may communicate with an electronic device 1302 via a first network 1398 (e.g., a short-range wireless communication network), or at least one of an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In some embodiments, at least one of the components (e.g., the connecting terminal 1378) may be omitted from the electronic device 1301, or one or more other components may be added in the electronic device 1301. In some embodiments, some of the components (e.g., the sensor module 1376, the camera module 1380, or the antenna module 1397) may be implemented as a single component (e.g., the display module 1360).

The processor 1320 may execute, for example, software (e.g., a program 1340) to control at least one other component (e.g., a hardware or software component) of the electronic device 1301 coupled with the processor 1320, and may perform various data processing or computation. According to one embodiment, as at least part of the data processing or computation, the processor 1320 may store a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor (ISP), a sensor hub processor, or a communication processor (CP)) that is operable independently from, or in conjunction with, the main processor 1321. For example, when the electronic device 1301 includes the main processor 1321 and the auxiliary processor 1323, the auxiliary processor 1323 may be adapted to consume less power than the main processor 1321, or to be specific to a specified function. The auxiliary processor 1323 may be implemented as separate from, or as part of the main processor 1321.

The auxiliary processor 1323 may control at least some of functions or states related to at least one component (e.g., the display module 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323. According to an embodiment, the auxiliary processor 1323 (e.g., the neural processing unit) may include a hardware structure specified for artificial intelligence model processing. An artificial intelligence model may be generated by machine learning. Such learning may be performed, e.g., by the electronic device 1301 where the artificial intelligence is performed or via a separate server (e.g., the server 1308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output sound signals to the outside of the electronic device 1301. The sound output module 1355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal and vice versa. According to an embodiment, the audio module 1370 may obtain the sound via the input module 1350, or output the sound via the sound output module 1355 or a headphone of an external electronic device (e.g., an electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high definition multimedia interface (HDMI), a universal serial bus (USB) interface, a secure digital (SD) card interface, or an audio interface.

A connecting terminal 1378 may include a connector via which the electronic device 1301 may be physically connected with the external electronic device (e.g., the electronic device 1302). According to an embodiment, the connecting terminal 1378 may include, for example, a HDMI connector, a USB connector, a SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to one embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device 1304 via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The wireless communication module 1392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the mmWave band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element composed of a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in the communication network, such as the first network 1398 or the second network 1399, may be selected, for example, by the communication module 1390 (e.g., the wireless communication module) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

According to various embodiments, the antenna module 1397 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 or 1304 may be a device of a same type as, or a different type, from the electronic device 1301. According to an embodiment, all or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using, e.g., distributed computing or mobile edge computing. In another embodiment, the external electronic device 1304 may include an internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

An electronic device 101 according to an embodiment may include a microphone 140, a memory 130, and at least one processor 120 and 125. According to an embodiment, the at least one processor may be configured to acquire speech data corresponding to a user's speech via the microphone. The at least one processor according to an embodiment may be configured to acquire a first text recognized on the speech data by at least partially performing at least one of automatic speech recognition (ASR) or natural language understanding (NLU) so as. The at least one processor according to an embodiment may be configured to identify, based on the first text, a second text stored in the memory. The at least one processor according to an embodiment may be configured to control to output the first text or the second text as a speech recognition result of the speech data, based on a difference between the first text and the second text. The at least one processor according to an embodiment may be configured to acquire training data for recognition of the user's speech, based on relevance between the first text and the second text with respect to the speech data.

The at least one processor according to an embodiment may be configured to, based on identifying that the training data is accumulated by a designated amount, learn a feature vector analysis model for recognizing the user's speech, based on the training data.

The at least one processor according to an embodiment may be configured to, based on identifying that the difference between the first text and the second text is equal to or less than a designated value, acquire the training data for recognition of the speech data as the second text.

The at least one processor according to an embodiment may be configured to determine a relationship between the first text and the second text to be an utterance characteristic of the user.

The at least one processor according to an embodiment may be configured to, based on identifying that the difference between the first text and the second text is equal to or less than the designated value, control to output the second text as the speech recognition result.

The at least one processor according to an embodiment may be configured to, based on identifying that the difference between the first text and the second text exceeds the designated value, control to output the first text as the speech recognition result.

The at least one processor according to an embodiment may be configured to, based on the first text, identify at least one utterance intent included in the speech data. The at least one processor according to an embodiment may be configured to identify the second text from among a plurality of texts stored in the memory, based on the at least one utterance intent.

The at least one processor according to an embodiment may be configured to identify an utterance pattern of the speech data, based on the at least one utterance intent. The at least one processor according to an embodiment may be configured to store, in the memory, the utterance pattern as information on the utterance characteristic of the user.

The at least one processor according to an embodiment may be configured to divide each of the first text and the second text in units of phonemes. The at least one processor according to an embodiment may be configured to identify the difference between the first text and the second text, based on similarities between a plurality of first phonemes included in the first text and a plurality of second phonemes included in the second text.

The at least one processor according to an embodiment may be configured to extract features of the speech data acquired from the user. The at least one processor according to an embodiment may be configured to extract a feature vector of the speech data, based on the features. The at least one processor according to an embodiment may be configured to acquire speech-recognized multiple speech recognition candidates, based on the feature vector. The at least one processor according to an embodiment may be configured to determine the first text, based on matching probabilities of the multiple speech recognition candidates determined by at least one language model. The at least one processor according to an embodiment may be configured to, based on information of the user's utterance characteristic and the user's personal information stored in the memory, determine whether to replace the first text with the second text, as the speech recognition result from among the multiple speech recognition candidates. The at least one processor according to an embodiment may be configured to display, as the speech recognition result, the first text or the second text on the display 160 included in the electronic device.

An operation method of an electronic device 101 according to an embodiment may include acquiring speech data corresponding to a user's speech via a microphone 140 included in the electronic device. The operation method of the electronic device according to an embodiment may include acquiring a first text recognized on the speech data by at least partially performing at least one of automatic speech recognition (ASR) or natural language understanding (NLU). The operation method of the electronic device according to an embodiment may include identifying, based on the first text, a second text stored in the electronic device. The operation method of the electronic device according to an embodiment may include controlling to output the first text or the second text as a speech recognition result of the speech data, based on a difference between the first text and the second text. The operation method of the electronic device according to an embodiment may include acquiring training data for recognition of the user's speech, based on relevance between the first text and the second text with respect to the speech data.

The operation method of the electronic device according to an embodiment may further include, based on identifying that the training data is accumulated by a designated amount, training a feature vector analysis model for recognizing the user's speech, based on the training data.

The acquiring of the training data according to an embodiment may include, based on identifying that the difference between the first text and the second text is equal to or less than a designated value, acquiring the training data for recognition of the speech data as the second text.

The acquiring of the training data according to an embodiment may include determining a relationship between the first text and the second text to be an utterance characteristic of the user.

The controlling to output the first text or the second text as the speech recognition result according to an embodiment may include, based on identifying that the difference between the first text and the second text is equal to or less than the designated value, controlling to output the second text as the speech recognition result.

The controlling to output the first text or the second text as the speech recognition result according to an embodiment may include, based on identifying that the difference between the first text and the second text exceeds the designated value, controlling to output the first text as the speech recognition result.

The operation method of the electronic device according to an embodiment may further include identifying, based on the first text, at least one utterance intent included in the speech data. The operation method of the electronic device according to an embodiment may further include identifying the second text among a plurality of texts stored in the memory, based on the at least one utterance intent.

The operation method of the electronic device according to an embodiment may further include identifying an utterance pattern of the speech data, based on the at least one utterance intent. The operation method of the electronic device according to an embodiment may further include storing, in the memory, the utterance pattern as information on the utterance characteristic of the user.

The operation method of the electronic device according to an embodiment may further include dividing each of the first text and the second text in units of phonemes. The operation method of the electronic device according to an embodiment may further include identifying the difference between the first text and the second text, based on similarities between a plurality of first phonemes included in the first text and a plurality of second phonemes included in the second text.

A non-transitory recording medium 130 according to an embodiment may store a program configured to perform acquiring speech data corresponding to a user's speech via a microphone 140 included in an electronic device 101, acquiring a first text recognized on the speech data by at least partially performing at least one of automatic speech recognition (ASR) or natural language understanding (NLU), identifying, based on the first text, a second text stored in the electronic device, controlling to output the first text or the second text as a speech recognition result of the speech data, based on a difference between the first text and the second text, and acquiring training data for recognition of the user's speech, based on relevance between the first text and the second text with respect to the speech data.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor (e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a microphone;
memory storing at least one instruction; and
at least one processor configured to execute the at least one instruction to:
acquire, through the microphone, speech data corresponding to a user's speech,
acquire a first text based on the speech data by at least partially performing at least one of automatic speech recognition (ASR), or natural language understanding (NLU),
identify a second text stored in the memory based on the first text,
output the first text or the second text as a speech recognition result of the speech data based on a difference between the first text and the second text, and
acquire training data for recognition of the user's speech based on a relevance between the first text and the second text with respect to the speech data.

2. The electronic device of claim 1, wherein the at least one processor is further configured to execute the at least one instruction to:
based on accumulating a designated amount of the training data, learn a feature vector analysis model for recognizing the user's speech, based on the training data.

3. The electronic device of claim 1, wherein the at least one processor is further configured to execute the at least one instruction to:
based on the difference between the first text and the second text being equal to or less than a designated value, acquire the training data for recognition of the speech data as the second text.

4. The electronic device of claim 3, wherein the at least one processor is further configured to execute the at least one instruction to:
determine a relationship between the first text and the second text to be an utterance characteristic of the user.

5. The electronic device of claim 3, wherein the at least one processor is further configured to execute the at least one instruction to:
based on the difference between the first text and the second text being equal to or less than the designated value, output the second text as the speech recognition result.

6. The electronic device of claim 3, wherein the at least one processor is further configured to execute the at least one instruction to:
based on the difference between the first text and the second text exceeding the designated value, output the first text as the speech recognition result.

7. The electronic device of claim 1, wherein the at least one processor is further configured to execute the at least one instruction to:
based on the first text, identify at least one utterance intent included in the speech data; and
based on the at least one utterance intent, identify the second text from among a plurality of texts stored in the memory.

8. The electronic device of claim 7, wherein the at least one processor is further configured to execute the at least one instruction to:
based on the at least one utterance intent, identify an utterance pattern of the speech data; and
store, in the memory, the utterance pattern as information on an utterance characteristic of the user.

9. The electronic device of claim 1, wherein the at least one processor is further configured to execute the at least one instruction to:
divide each of the first text and the second text in units of phonemes; and
identify the difference between the first text and the second text, based on similarities between a plurality of first phonemes in the first text and a plurality of second phonemes in the second text.

10. The electronic device of claim 1, wherein the at least one processor is further configured to execute the at least one instruction to:
extract features of the speech data acquired from the user;
based on the features, extract a feature vector of the speech data;
based on the feature vector, acquire speech-recognized multiple speech recognition candidates;
determine the first text, based on matching probabilities of the multiple speech recognition candidates determined by at least one language model;
determine whether to replace the first text with the second text, as the speech recognition result from among the multiple speech recognition candidates, based on information of at least one utterance characteristic of the user and a personal information of the user stored in the memory; and
display, through a display of the electronic device, the speech recognition result of the speech data.

11. A method of operating an electronic device, comprising:
acquiring, through a microphone of the electronic device, speech data corresponding to a user's speech;
acquiring a first text based on the speech data by at least partially performing at least one of automatic speech recognition (ASR) or natural language understanding (NLU);
identifying a second text stored in the electronic device based on the first text;
outputting the first text or the second text as a speech recognition result of the speech data based on a difference between the first text and the second text; and
acquiring training data for recognition of the user's speech based on a relevance between the first text and the second text with respect to the speech data.

12. The method of claim 11, further comprising:
based on accumulating a designated amount of the training data, training a feature vector analysis model for recognizing the user's speech, based on the training data.

13. The method of claim 11, wherein the acquiring the training data comprises:
based on the difference between the first text and the second text being equal to or less than a designated value, acquiring the training data for recognition of the speech data as the second text.

14. The method of claim 13, wherein the acquiring the training data comprises:
determining a relationship between the first text and the second text to be an utterance characteristic of the user.

15. The method of claim 11, wherein outputting the first text or the second text as the speech recognition result comprises:
based on the difference between the first text and the second text being equal to or less than the designated value, outputting the second text as the speech recognition result.

16. The method of claim 11, wherein outputting the first text or the second text as the speech recognition result comprises:
based on the difference between the first text and the second text exceeding the designated value, outputting the first text as the speech recognition result.

17. The method of claim 11, further comprising:
based on the first text, identifying at least one utterance intent included in the speech data; and
based on the at least one utterance intent, identifying the second text among multiple texts stored in the memory.

18. The method of claim 17, further comprising:
based on the at least one utterance intent, identifying an utterance pattern of the speech data; and
storing, in the memory, the utterance pattern as information on an utterance characteristic of the user.

19. The method of claim 11, further comprising:
dividing each of the first text and the second text in units of phonemes; and
identifying the difference between the first text and the second text, based on similarities between a plurality of first phonemes in the first text and a plurality of second phonemes in the second text.

20. A non-transitory computer readable medium for storing computer readable program code or instructions which are executable by a processor to perform a method for operating an electronic device, the method comprising:
acquiring, through a microphone of the electronic device, speech data corresponding to a user's speech;
acquiring a first text based on the speech data by at least partially performing at least one of automatic speech recognition (ASR) or natural language understanding (NLU);
identifying second text stored in the electronic device based on the first text;
controlling to output the first text or the second text as a speech recognition result of the speech data based on a difference between the first text and the second text; and
acquiring training data for recognition of the user's speech based on a relevance between the first text and the second text with respect to the speech data.
